(19) United States
(12) Patent Application Publication
(10) Pub. No.: US 2021/0398409 A1
(43) Pub. Date: Dec. 23, 2021

(54) HAZARD DETECTION SYSTEM

(71) Applicant: Akul Sri Datta, Palo Alto, CA (US)

(72) Inventor: Akul Sri Datta, Palo Alto, CA (US)

(21) Appl. No.: 17/466,437

(22) Filed: Sep. 3, 2021

Related U.S. Application Data
(63) Continuation of application No. 16/847,157, filed on Apr. 13, 2020, now abandoned.

(51) Int. Cl. G08B 21/02; G08G 1/01

(52) U.S. Cl. CPC G08B 21/02; G08G 1/0104

(57) ABSTRACT

A hazardous vehicle detection and avoidance system is disclosed comprising a wearable device comprising one or more sensors arranged to detect one or more vehicles in an environment. An object classification system is configured to classify objects in the environment, the object classification system is in operable communication with a comparator to compare sensor information received from the one or more sensors with object information stored in an object database and determine an object classification. An analysis engine to receive the object classification and determine a hazard level of the classified object. An alert system to transmit an alert to the wearable device to alert a pedestrian of a hazardous vehicle in the environment.

### CROSS-REFERENCE TO RELATED APPLICATIONS

The present application is a Continuation Patent Application and claims priority to U.S. Non-Provisional patent application Ser. No. 16/847,157 filed Apr. 13, 2020, entitled “HAZARD DETECTION SYSTEM,” which is hereby incorporated by reference in its entirety.

### TECHNICAL FIELD

The embodiments generally relate to pedestrian warning systems and, more specifically, relates to devices and systems for detecting hazards near a roadway.

### BACKGROUND

Vehicle travel presents a danger to vehicle operators, passengers, and pedestrians alike. Automotive accidents are an ongoing problem in the Unites States and worldwide, and they have continued to increase alongside rising populations and the prevalence of motor vehicle use. The introduction of electric cars may result in an increase in pedestrian injuries and deaths due to the silent operation of the vehicle as compared with combustion engines.

Vehicles are permitted to travel on roadways which often have painted lines to indicate the proper direction of travel, and to designates lanes for the vehicles to travel within. Sidewalks or other walking areas are positioned outside the roadway to allow pedestrians to move alongside vehicles relatively safely. In some areas, textured areas of the roadway, which are placed on the border or just outside the vehicle lane, cause a vibration within the vehicle. Although effective for alerting the vehicle occupants when a vehicle begins to travel outside of a lane, the vibration does not actively warn nearby pedestrians of the hazardous vehicle.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments provided herein relate to a hazardous vehicle detection and avoidance system comprising a wearable device comprising one or more sensors arranged to detect one or more vehicles in an environment. An object classification system is configured to classify objects in the environment, the object classification system is in operable communication with a comparator to compare sensor information received from the one or more sensors with object information stored in an object database and determine an object classification. An analysis engine to receive the object classification and determine a hazard level of the classified object. An alert system to transmit an alert to the wearable device to alert a pedestrian of a hazardous vehicle in the environment.

In one aspect, the one or more sensors comprise at least one of the following: at least one camera; at least one microphone; at least one radar system; at least one lidar system; at least one proximity sensor; at least one motion sensor; and at least one infrared sensor.

In one aspect, a machine learning engine is configured to receive input and to output alerts to the pedestrian.

In one aspect, the received input is comprised of: location information, pedestrian information, and hazard information.

In one aspect, the system further comprises a GPS system to receive location information from the wearable device.

In one aspect, a mapping engine to analyzes the travel path of the user and transmit an alert if the pedestrian enters a hazardous area.

In one aspect, the mapping engine analyzes speed limits of a plurality of roadways along the travel path of the pedestrian.

In one aspect, the wearable device is a smart watch.

In one aspect, an application system to permit the user to interact with a user interface and preselect a plurality of user settings.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the system, according to some embodiments;

FIG. 2 illustrates a schematic of the environment and a vehicle traveling in a permitted travel path, according to some embodiments;

FIG. 3 illustrates a schematic of the environment and a vehicle traveling in a potentially hazardous travel path, according to some embodiments;

FIG. 4 illustrates a block diagram of the object classification system, according to some embodiments;

FIG. 5 illustrates a block diagram of the device components, according to some embodiments;

FIG. 6 illustrates a block diagram of the application system, according to some embodiments;

FIG. 7 illustrates a block diagram of the hazardous vehicle detection and avoidance system, according to some embodiments;

FIG. 8 illustrates a block diagram of the network infrastructure, according to some embodiments; and

FIG. 9 illustrates a block diagram of the machine learning engine, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, the term “pedestrian” includes any person or groups of people outside of the vehicle.

As used herein, the term “vehicle” may refer to automobiles, motorcycles, buses, trains, bicycles, scooters, recreational vehicles, off-road vehicles, or other motorized vehicles operated on or near roadways.

In general, the embodiments provided herein relate to a system to detect hazardous vehicles and provide a pedestrian warning if a hazardous vehicle is detected. The system is configured to be portable such that the pedestrian (also referred to herein as the “user”) can transport the device on their person. The device may be configured as a wearable article or may be integrated with an existing wearable including textiles, accessories, smart watches, jewelry, eyewear, etc.

The system is configured to alert users of a potential hazard or of an imminent hazard of an approaching oncoming vehicle to provide an efficient means for preventing pedestrian-related vehicle accidents. Preferably, the device is an affordable implement for sensing vehicles in an environment.

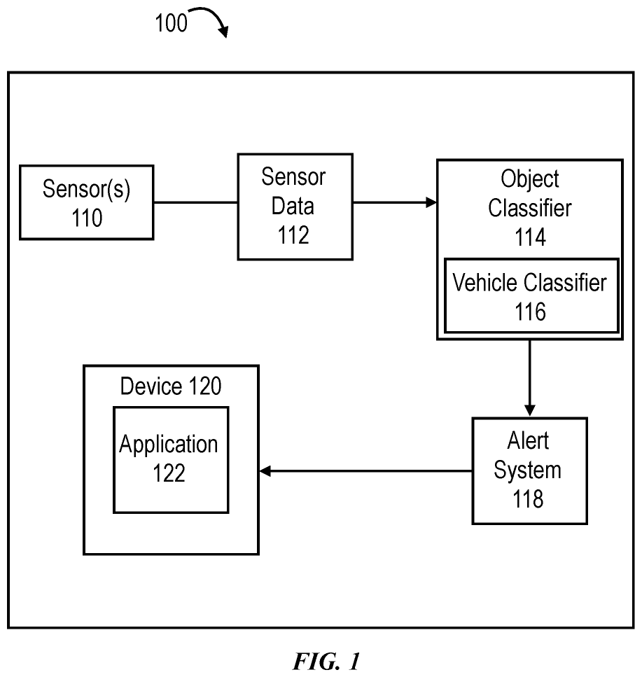

In reference to FIG. 1, the system 100 is illustrated comprising at least one sensor 110 adapted to detect motion of an object in the environment of the pedestrian. The sensor(s) 110 are positioned to detect vehicles by transmitting sensor data 112 from the sensor(s) 110 to an object classifier 114 configured to classify objects from the sensor data 112 detected by the sensor(s) 110. The object classifier 114 provides a means for classifying the object as a hazard, a potential hazard, an inanimate object, or a non-threat. A vehicle classifier 116 may operate to classify the vehicle type and transmit the vehicle type to the object classifier. An alert system 118 provides an output to the pedestrian such as an alarm or notification to a device 120 which may include smart device, a wearable worn on the user, or another audio, visual, tactile, or other alert system. The device 120 may include an application 122 downloaded to the device to display the alert on the device 120. The application 122 may also provide a means for the user to interact with the various functionalities of the system described herein.

In some embodiments, the object classifier 114 determines if the object data represents an object that is moving towards the pedestrian along a safe travel path or along a potentially hazardous travel path. Further, the object classifier 114 may comprise a vehicle classifier 116 to determine the object type, which may include the vehicle type, and transmit an output signal to the application 122 to indicate the object and/or vehicle type.

In some embodiments, the at least one sensor 110 may include one or more audio sensors, light sensors, radar systems, lidar systems, proximity sensors, motion sensors, laser systems, or other object detection systems known in the arts. Sensors 110 may be configured to monitor vehicle speed, acceleration, direction, size, shape, driving characteristics, or other hazards present in the environment which may endanger the pedestrian. In one example, the device sensors 110 detect that an approaching vehicle is traveling at a rate of speed that exceeds the speed limit for the road the vehicle is traveling on.

In an exemplary embodiment, the sensors may include a camera system such as, for example, a Raspberry Pi 3 Model B+ including a Picamera to sufficiently monitor the environment and detect objects within the environment which may present a hazard.

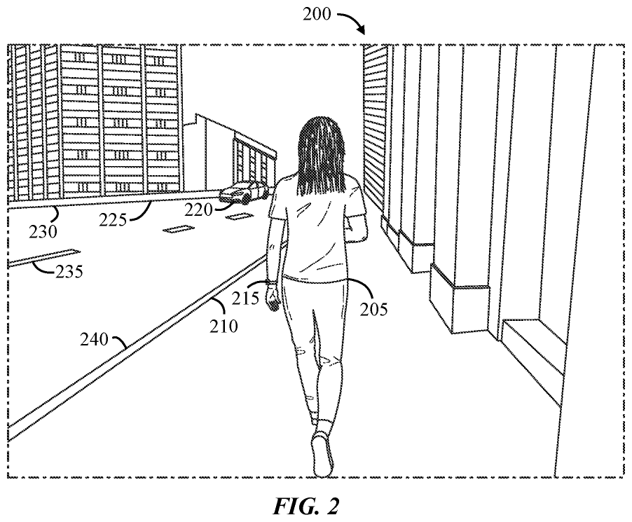

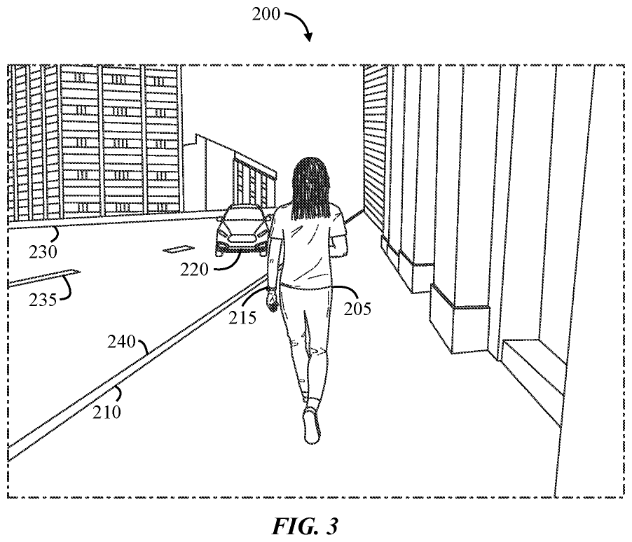

FIG. 2 and FIG. 3 illustrate a schematic of an environment 200 including a pedestrian 205 traveling on a sidewalk 210. While a sidewalk is illustrated, the system may define various pedestrian-permitted areas. The system may learn areas where the pedestrian 205 is permitted to travel using machine learning techniques based on travel characteristics of the pedestrian, roadway mapping, and/or learned risks experienced in environments 200 by the pedestrian 205 or other users of the system. The pedestrian 205 is in communication with a device 215 comprising the one or more sensor(s) arranged to monitor the environment and transmit the sensor data to the system. The device 215 may be a wearable smart device to permit communication with the system via a network.

In further reference to FIG. 2, the vehicle 220 is traveling along roadway 225 toward the pedestrian 205. The vehicle 220 is within the designated lane 230. The sensors in the device 215 detect the vehicle 220 and determine that the vehicle 220 is traveling in a safe manner that is not hazardous to the pedestrian 205. In some embodiments, the safe travel path may be defined by the vehicle 220 not passing a threshold, such as a lane marker 235 or sidewalk barrier 240.

As illustrated in FIG. 3, the vehicle 220 is shown traveling in a hazardous direction towards the pedestrian 205. The device 215 detects the hazardous travel path of the vehicle 220 using the object classifier, vehicle classifier, and artificial intelligence and/or machine learning techniques to alert the pedestrian 205 via the device. The alert signal may be transmitted once the vehicle travels outside the designated lane 230, outside the lane marker 235, nears a sidewalk barrier 240, or another threshold which may be indicative of a potential hazard.

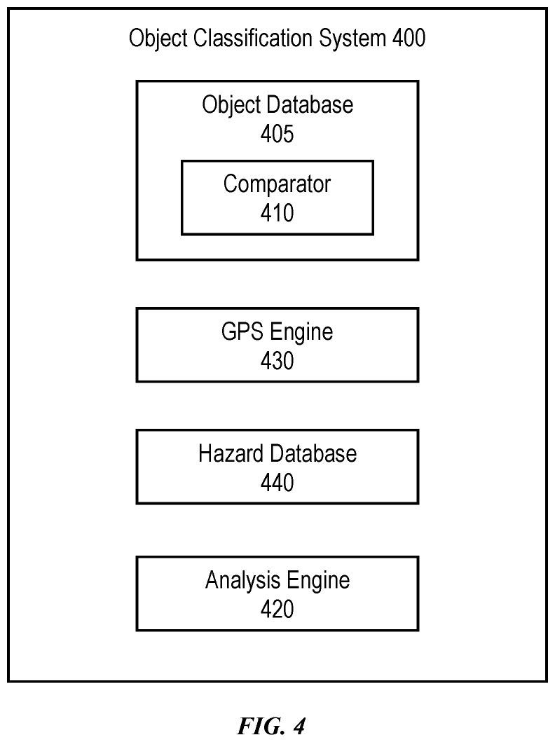

FIG. 4 illustrates a block diagram of the object classification system 400 comprising an object database 405 comprising a database of object information including imagery, sensory data, etc. to permit a comparator 410 to compare the object data received from the sensors disposed within the device. The object data may further comprise a definition of relevant object classes which have the potential to result in a hazard to the pedestrian. The comparator determines a classification for the object and the object data with an analysis engine 420 to determine the vehicle travel path, and potential hazardous associated with the vehicles travel characteristics. A GPS engine 430 determines the position of the pedestrian. The GPS system may communicate with a hazard database 440 which stores information related to hazards in various areas.

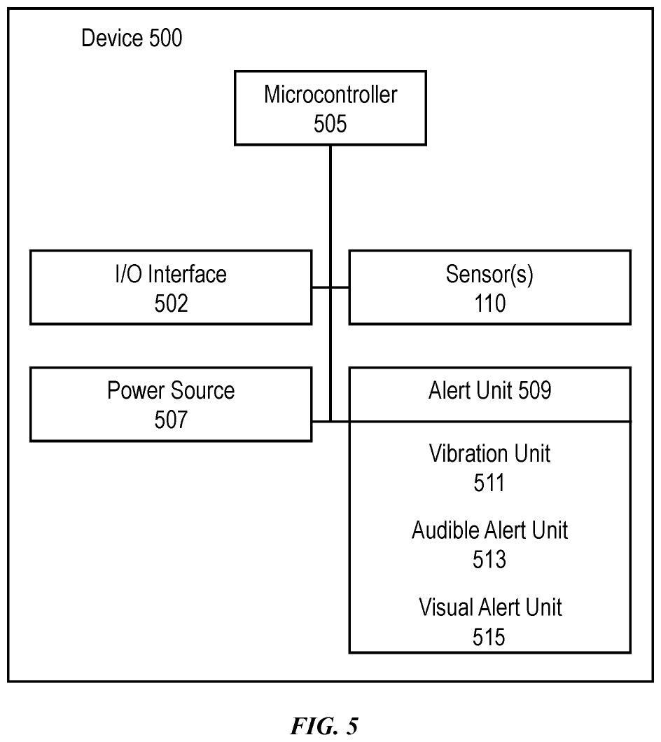

FIG. 5 illustrates a block diagram of the device 500 components including a I/O interface 502 permitting the user to input functional controls to the device including ON/OFF functions, sensitivity functions, alert functions, etc. The sensitivity functions may permit the user to indicate how sensitive the device should be when monitoring vehicles or when transmitting an alert signal. A microcontroller 505 receives the input from the user and is disposed within the housing of the device. The microcontroller 505 is in operable communication with the sensor(s) 110, I/O interface 502, and a power source 507. The microcontroller 505 may operate to control output of sensor data and the software configured to convert the sensor data into an alert signal transmitted to the device 500. The sensor(s) 110 are in operational control with the microcontroller 505 such that the microcontroller 505 instructs the camera to monitor moving objects, or other potentially hazardous objects in the environment. An alert unit 509 is in communication with the microcontroller 505 and emits a tactile, visual, or audible alert if an alert signal is received due to a hazardous vehicle. The alert unit 509, may include a vibration unit 511, an audible alert unit 513, or a visual alert unit 515.

The vibration unit 511 is disposed within the device. The vibration unit 511 is in operational communication with the microcontroller 505 and the power source and is configured to vibrate to notify the pedestrian of an on-coming hazardous motor vehicle. The vibration unit provides haptic or tactile feedback to the pedestrian which may be especially useful in loud environments.

The audible alert unit 513 may comprise one or more speakers disposed within the device. The audible alert unit 513 is in operational communication with the microcontroller and the power source 507 and is configured audibly alert the pedestrian of an on-coming hazardous motor vehicle.

The visual alert unit 515 may comprise one or more lights disposed within the device. The visual alert unit 515 is in operational communication with the microcontroller 505 and the power source 507 to emit a light pattern or other visual alert to the pedestrian that an on-coming hazardous motor vehicle is approaching.

In some embodiments, the sensor(s) 110 may include at least one camera disposed within the housing of the device 500. The camera may include a flash to aid the capture of imagery in low light conditions.

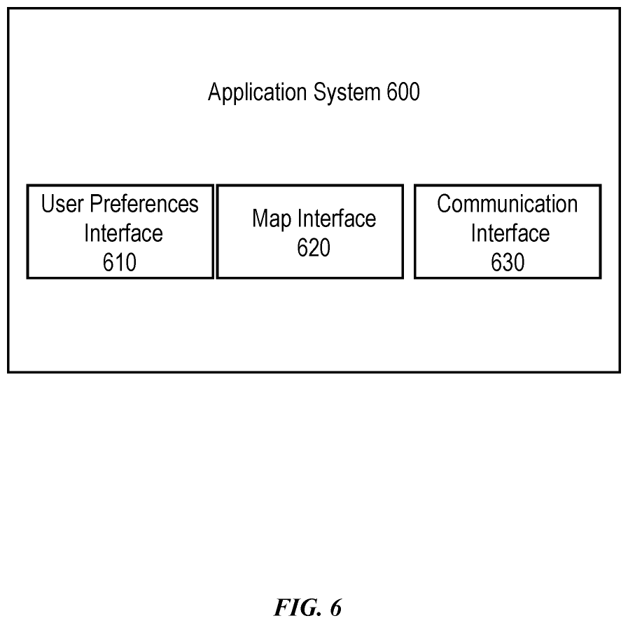

FIG. 6 illustrates the application system 600 provided on a computing device to allow the user to interact with various functionalities of the system described in the various embodiments herein. The application system 600 includes a user preferences interface 610 which permits the user to select from various settings such as alert sensitivity, preferred alert type, sensor sensitivity, storage settings, user profile settings, and the like. A map interface 620 may provide a map from the GPS location of the user and suggest a route for the pedestrian to travel. A communication interface 630 may allow users to communicate with one another to share alerts of potential hazards in an area.

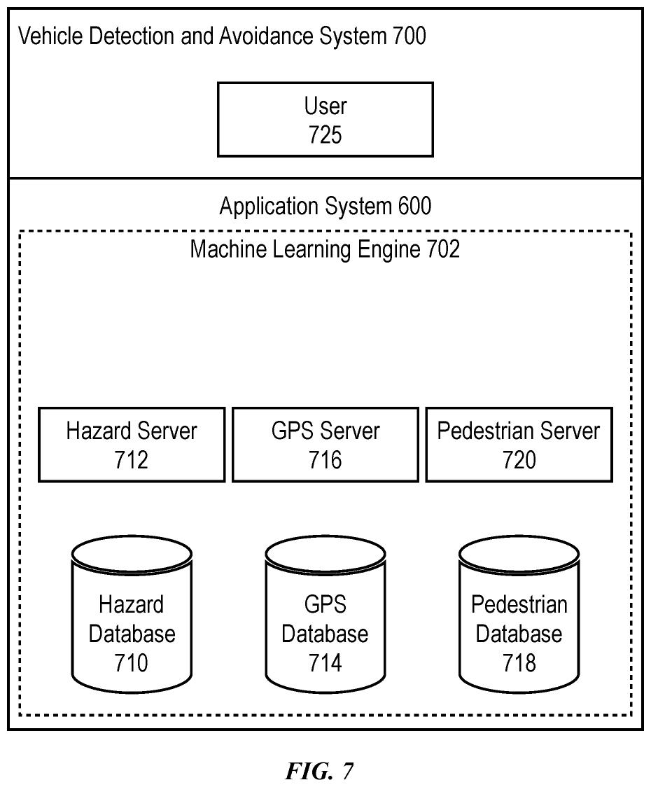

FIG. 7 illustrates a block diagram of the hazardous vehicle detection and avoidance system 700 comprising a machine learning engine 702 which receives information from a plurality of devices each comprising one or more sensors. The machine learning engine 702 further comprises a hazard database 710 to store hazardous events. A hazard server 712 transmits hazard information to and from the hazard database 710. A GPS database 714 stores location information for each user of the system. The location information may be transmitted via a GPS server 716 to the machine learning engine 702. A pedestrian database 718 stores pedestrian information, including travel paths, user preferences, alert settings, and other user information, and transmits the pedestrian information to the machine learning engine 702 via the pedestrian server 720. A user 725 is in operable communication with the application system 600 which receives information transmitted by the hazardous vehicle detection and avoidance system 700.

In some embodiments, the GPS database 714 may include mapping information, including speed limits which may be used to assess a hazard level for vehicle in the environment of the pedestrian.

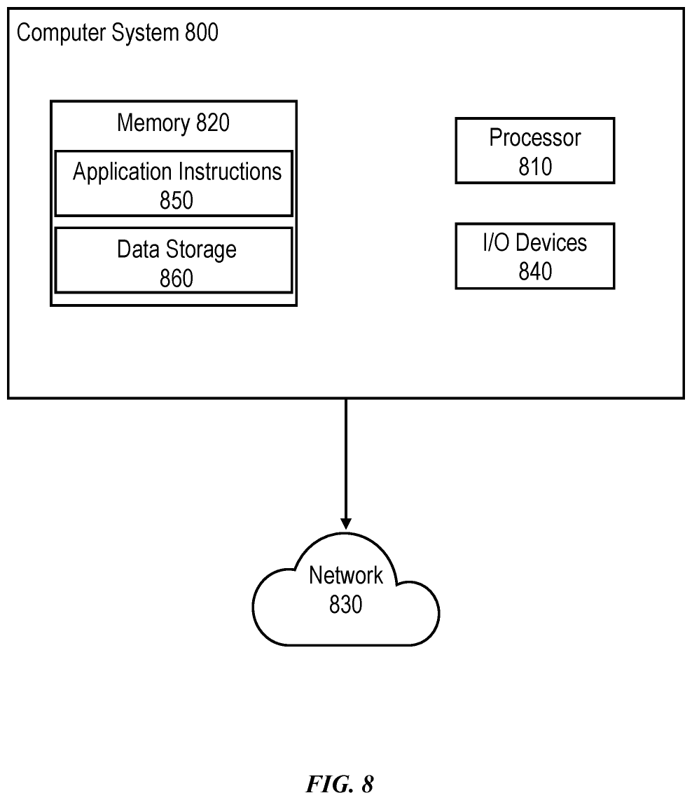

FIG. 8 illustrates a computer system 800, which may be utilized to execute the processes described herein. The computer system 800 is comprised of a standalone computer or mobile computing device, a mainframe computer system, a workstation, a network computer, a desktop computer, a laptop, or the like. The computer system 800 includes one or more processors 810 coupled to a memory 820 via an input/output (I/O) interface. Computer system 800 may further include a network interface to communicate with the network 830. One or more input/output (I/0) devices 840, such as video device(s) (e.g., a camera), audio device(s), and display(s) are in operable communication with the computer system 800. In some embodiments, similar I/O devices 840 may be separate from computer system 800 and may interact with one or more nodes of the computer system 800 through a wired or wireless connection, such as over a network interface.

Processors 810 suitable for the execution of a computer program include both general and special purpose microprocessors and any one or more processors of any digital computing device. The processor 810 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 800 and other devices attached to a network 830, such as other computer systems, or between nodes of the computer system 800. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol.

The memory 820 may include application instructions 850, configured to implement certain embodiments described herein, and a database 860, comprising various data accessible by the application instructions 850. In one embodiment, the application instructions 850 may include software elements corresponding to one or more of the various embodiments described herein. For example, application instructions 850 may be implemented in various embodiments using any desired programming language, scripting language, or combination of programming languages and/or scripting languages (e.g., C, C++, C#, JAVA®, JAVASCRIPT®, PERL®, etc.).

The steps and actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 810 such that the processor 810 can read information from, and write information to, the storage medium. In the alternative, the storage medium may be integrated into the processor 810. Further, in some embodiments, the processor 810 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

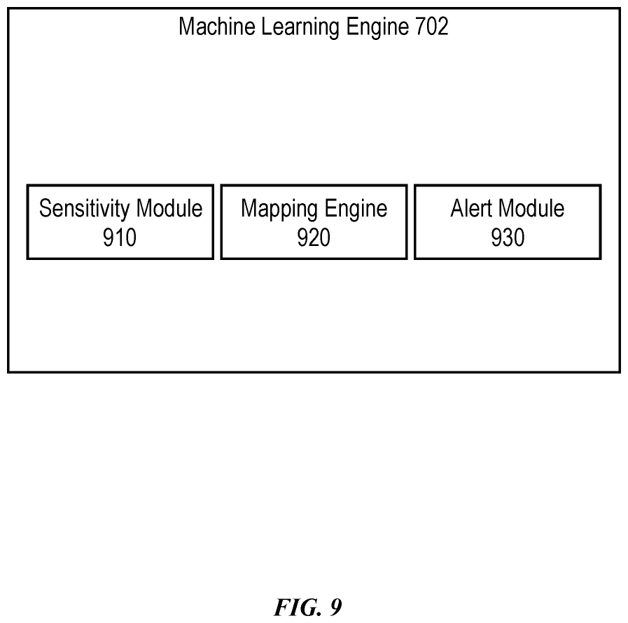

FIG. 9 illustrates a server engine 900 and modules for the application system. The server engine 900 may transmit information to the machine learning engine 702 for analysis and processing to output various alerts depending on the vehicle classification. A sensitivity module 910 may change the sensor sensitivity based on user preferences or input from the machine learning engine 702. For example, the sensor sensitivity may be changed depending on the roadway the pedestrian is traveling along. A highway for example, may need less sensitivity due to the high speed limit of the roadway. A mapping engine 920 receives pedestrian travel information and determines a likely travel path for the pedestrian. This may aid the alert module 930 when determining if a preventative alert should be sent to the pedestrian. For example, a preventative alert may be transmitted when the pedestrian enters a hazardous area where vehicles are likely to be speeding around a blind turn.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A hazardous vehicle detection and avoidance system, comprising:
a wearable device comprising one or more sensors arranged to detect one or more vehicles in an environment;
an object classification system configured to classify objects in the environment, the object classification system in operable communication with a comparator to compare sensor information received from the one or more sensors with object information stored in an object database and determine an object classification;
an analysis engine to receive the object classification and determine a hazard level of the classified object; and
an alert system to transmit an alert to the wearable device to alert a pedestrian of a hazardous vehicle in the environment.

2. The system of claim 1, wherein the one or more sensors comprise at least one of the following:
at least one camera;
at least one microphone;
at least one radar system;
at least one lidar system;
at least one proximity sensor;
at least one motion sensor; and
at least one infrared sensor.

3. The system of claim 1, further comprising a machine learning engine to receive input and to output alerts to the pedestrian.

4. The system of claim 3, wherein the received input is comprised of: location information, pedestrian information, and hazard information.

5. The system of claim 4, further comprising a GPS system to receive location information from the wearable device.

6. The system of claim 5, further comprising a mapping engine to analyze the travel path of the user and transmit an alert if the pedestrian enters a hazardous area.

7. The system of claim 6, wherein the mapping engine analyzes speed limits of a plurality of roadways along the travel path of the pedestrian.

8. The system of claim 7, wherein the wearable device is a smart watch.

9. The system of claim 8, further comprising an application system to permit the user to interact with a user interface and preselect a plurality of user settings.

10. A hazardous vehicle detection and avoidance system, comprising:
a wearable device comprising one or more sensors arranged to detect one or more vehicles in an environment;
an object classification system in operable communication with a machine learning engine, the object classification system configured to classify objects in the environment, the object classification system in operable communication with a comparator to compare sensor information received from the one or more sensors with object information stored in an object database and determine an object classification;
an analysis engine to receive the object classification and determine a hazard level of the classified object; and
an alert system to transmit an alert to an application system provide on the wearable device to alert a pedestrian of a hazardous vehicle in the environment.

11. The system of claim 1, wherein the one or more sensors comprise at least one of the following:
at least one camera;
at least one microphone;
at least one radar system;
at least one lidar system;
at least one proximity sensor;
at least one motion sensor; and
at least one infrared sensor.

12. The system of claim 10, wherein input is received by the machine learning engine from an application system, the received input is comprised of: location information, pedestrian information, and hazard information.

13. The system of claim 12, further comprising a GPS system to receive location information from the wearable device.

14. The system of claim 13, further comprising a mapping engine to analyze the travel path of the user and transmit an alert if the pedestrian enters a hazardous area.

15. The system of claim 14, wherein the mapping engine transmits a suggested travel path to the wearable device to reduce the likelihood of the pedestrian encountering a hazardous vehicle.

16. The system of claim 15, wherein the mapping engine analyzes speed limits of a plurality of roadways along the travel path of the pedestrian.

17. The system of claim 16, wherein the wearable device is a smart watch.

18. The system of claim 17, further comprising an application system to permit the user to interact with a user interface and preselect a plurality of user settings.

19. The system of claim 18, wherein the alert system outputs at least one of the following:
a tactile alert;
a visual alert; and
an audible alert.

20. A hazardous vehicle detection and avoidance system, comprising:
a wearable device releasably mounted on a pedestrian comprising at least one camera arranged to detect one or more vehicles in an environment;
an object classification system in operable communication with a machine learning engine, the object classification system configured to classify objects in the environment as a hazard, a non-hazard, or a potential hazard, the object classification system in operable communication with a comparator to compare sensor information received from the one or more sensors with object information stored in an object database and determine the object classification;
an analysis engine to receive the object classification and determine a hazard level of the classified object; and
an alert system to transmit an alert to an application system provide on the wearable device to alert a pedestrian of a hazardous vehicle in the environment, the alert system providing at least one of the following: a tactile alert, a visual alert, and an audible alert.
